(19) United States
(12) Patent Application Publication
(10) Pub. No.: US 2004/0125547 A1
(43) Pub. Date: Jul. 1, 2004

(54) Multi-mode modulation and display device of heat dissipating fans of computer power supply

(76) Inventor: Yen Tsai Tsung, Taipei Hsien (TW)

Correspondence Address: Yen Tsai Tsung, 235 Chung-Ho, Box 8-24, Taipei, TW

(21) Appl. No.: 10/725,123

(22) Filed: Dec. 2, 2003

(30) Foreign Application Priority Data
Dec. 11, 2002 (TW) 091220080

(51) Int. Cl. H02B 1/00

(52) U.S. Cl. 361/676; 713/300

(57) ABSTRACT

A multi-mode modulation and display device of heat dissipating fans of a computer power supply is disclosed. A modulation and display device is installed within a computer power supply. The modes of the modulation and display device are changeable. Thereby, in standby, the noise of the power supply is reduced and as operation in higher temperature, the heat dissipating fan can be driven to be operated with a higher speed. The modulation and display device includes a switching and display module having lamps for displaying the operation condition of fans. Thereby, the condition of the fans can be viewed by and alerted to the uses. Speeds of the fans are adjustable by using a sensor to sense the temperature variation of the environment and using a control unit to actuate the switching and display module so as to change the rotation speed of the heat dissipating fans.

### FIELD OF THE INVENTION

The present invention relates to power supplies of computers, and particular to a multi-mode modulation and display device of heat dissipating fans of a computer power supply. Speeds of the fans are adjustable by using a sensor to sense the temperature variation of the environment and using a control unit to actuate the switching and display module so as to change the rotation speed of the heat dissipating fans.

### BACKGROUND OF THE INVENTION

Power supplies are installed in the mainframes of computers, which is connected to outer supplied power for regulating and rectifying so as to supply power to the mainframe. Currently, the speeds of CPUs, such as Pentium series CPUs or CPUs of AMDK 7, have achieved to a speed of 2.4 GHz. Even the CD drives installed in computers have a speed over 7200 rpm. Thereby, the power supplies of computers must have higher capacities and output power. Thereby, the heat dissipation in operation of the power supplies is increased dramatically.

To solve the problem of increment of heat dissipation, a plurality of heat dissipating fans are installed on the peripheries of the power supplies (referring to FIG. 1) for dissipating heat.

However, in practical use, computers are not always in high speed, for example, in sleeping mode in that power consume is less than one tenth of the whole loading. At this moment, the output of power supply is small and thus the interior temperature of the power supply is smaller. It is necessary to reduce the rotation speed of the heat dissipating fans so as to reduce the noise in operation and thus to reduce the power consumption. Moreover, when the output power of the power supply is larger, the rotation speed of the fan must be increased for satisfying the necessity of the computer. However, in prior art, the speed of the fan is fixed and thus the speed of the fan cannot be adjusted according to the power consumption of the computer.

### SUMMARY OF THE INVENTION

Accordingly, the primary object of the present invention is to provide a multi-mode modulation and display device of a heat dissipating fan of a computer power supply, wherein a modulation and display device is installed within a computer power supply. As desire of the user, the modes of the modulation and display device are changeable. Thereby, in standby, the noise of the power supply is reduced and in operation in higher temperature, the heat dissipating fan can be driven in a higher speed.

Another object of the present invention is to provide a multi-mode modulation and display device of a heat dissipating fan of a computer power supply, wherein the modulation and display device includes a switching and display module having lamps for displaying the operation condition of fans. Thereby, the condition of the fans can be viewed by and alerted to the uses.

A further object of the present invention is to provide a multi-mode modulation and display device of a heat dissipating fan of a computer power supply, wherein speeds of the fans are adjustable by using a sensor to sense the temperature variation of the environment and using a control unit to actuate the switching and display module so as to change the rotation speed of the heat dissipating fans. Thereby, even in low rotation speed, the heat dissipating fan is adjustable automatically.

The various objects and advantages of the present invention will be more readily understood from the following detailed description when read in conjunction with the appended drawing.

### BRIEF DESCRIPTION OF THE DRAWINGS

FIG. 1 is a schematic view showing the prior art computer power supply.

FIG. 2 is a block diagram showing the component structure of the present invention.

FIG. 3 is a circuit diagram of the present invention.

FIG. 4 shows the relation curve of the resistance of the thermal resistor of the sensor with respect to the temperature variation according to the present invention.

FIG. 5 shows the relation curve of the temperature variation of the present invention with respect to the rotation speed at the automatic temperature control mode.

FIG. 6 shows the relation curves of the voltages of the heat dissipating fan with the rotate speed according to the present invention.

FIG. 7 is a perspective view showing one application of the present invention.

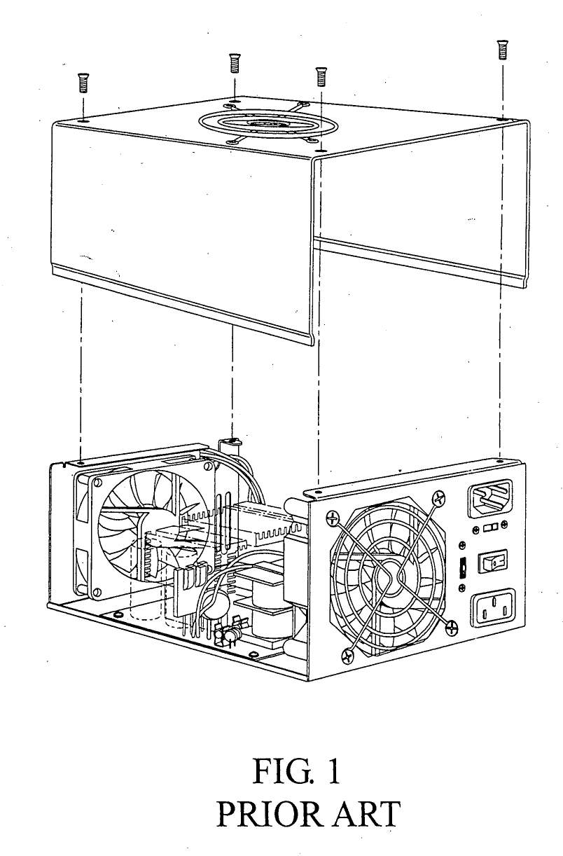

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

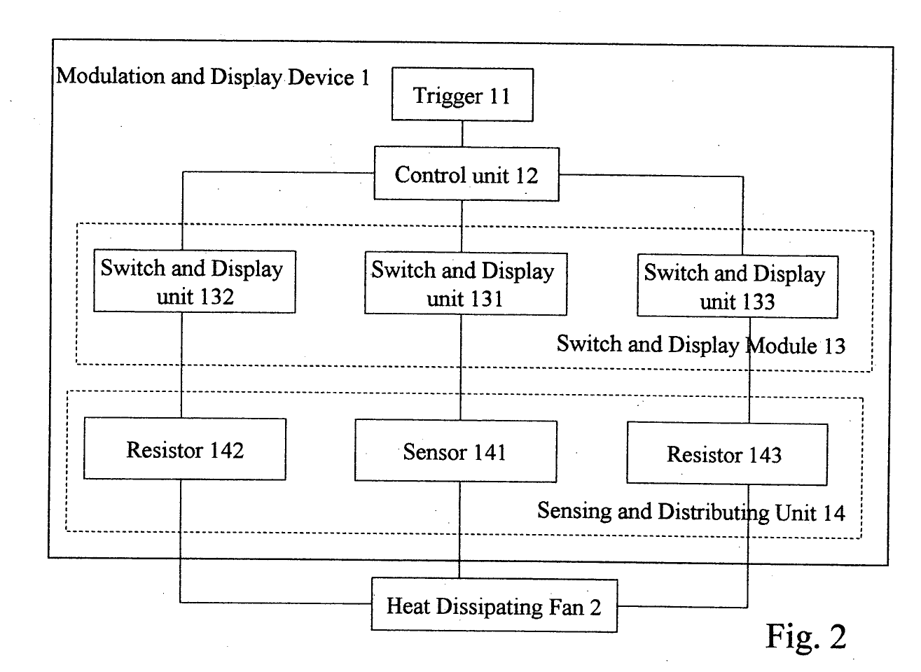

With reference to FIGS. 2, 3 and 7, the multi-mode modulation and display device of a heat dissipating fan of a computer power supply according to the present invention is illustrated. The modulation and display device 1 has an input end connected to a power supply and an output end thereof is electrically connected to at least one heat dissipating fan 2. The modulation and display device 1 includes the following elements.

A trigger 11 is a key switch or a thin film switch. The trigger 11 is driven by users directly or indirectly through a computer. The trigger 11 generates a pulse signal. For example, the trigger is connected to a computer mainframe so that the user can control the trigger through a computer having the computer mainframe.

A control unit 12 is actuated by the pulse signals from the trigger 11 to act sequentially.

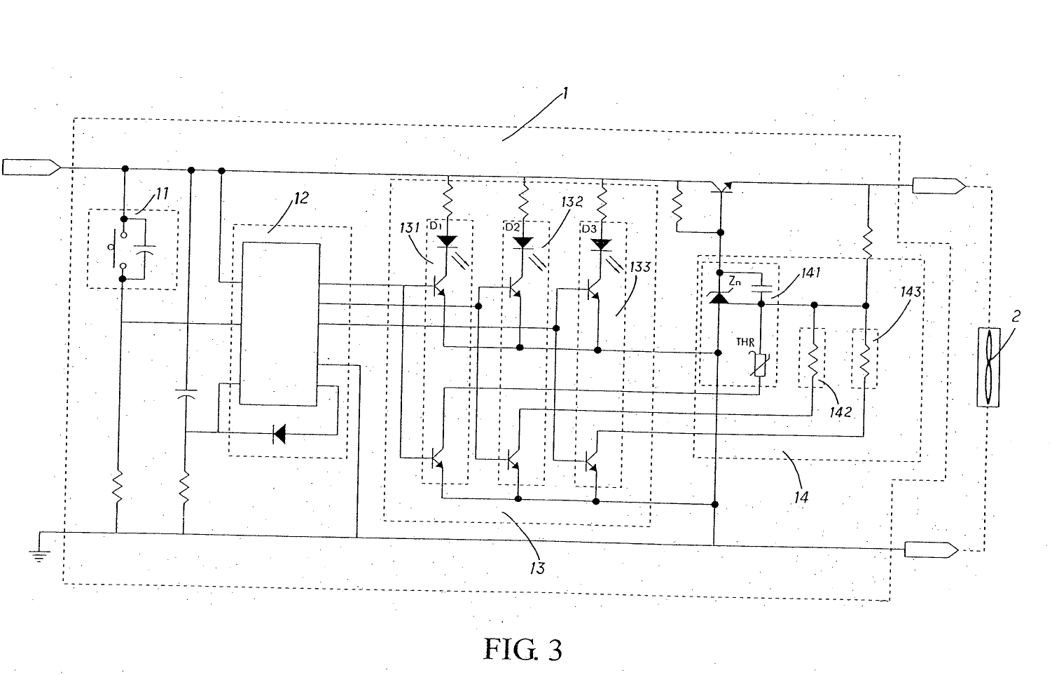

A switching and display module 13 is formed by at least three switching and display units 131, 132, and 133. The output end of the switching and display module 13 is connected to output ends of the control unit 12. When the output ends of the control unit 12 is conducted, the switching and display units 131, 132, and 133 connected to the control unit 12 is conducted so that the LED lights D1, D2 and D3 in the switching and display units 131, 132, and 133 light up (referring to FIG. 3).

A sensing and distributing unit 14 is connected to an output end of the switching and display module 13. The sensing and distributing unit 14 includes at least one sensor 141 and at least two resistors 142, 143 with different resistances. The sensor 141 is a thermal resistor THR and is driven by the switching and display module 13 for detecting the temperature variation of the environment and then changing the resistance thereof.

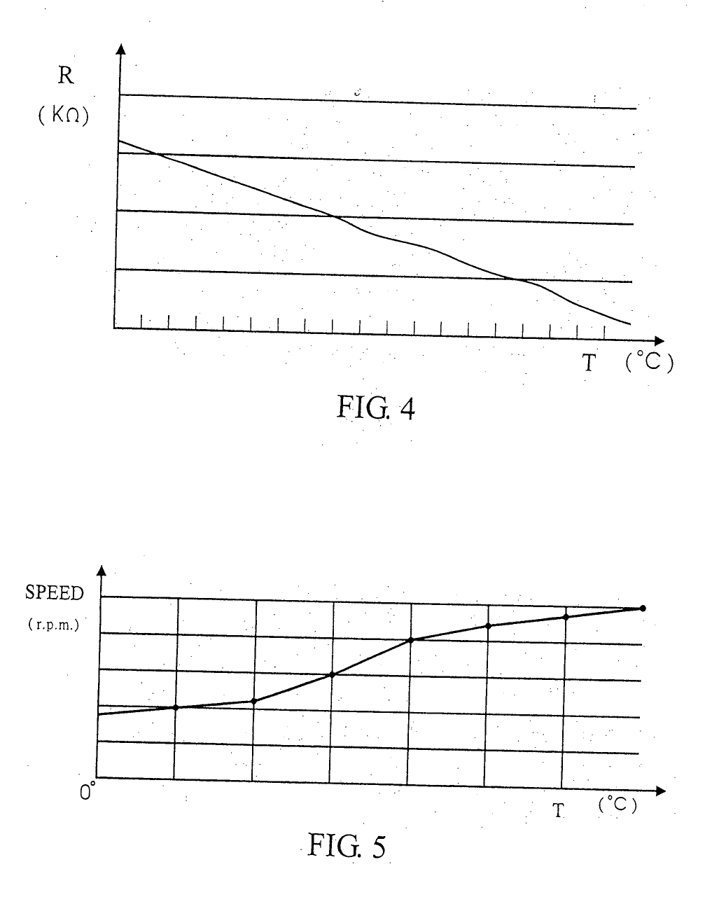

A Zener diode Zn runs across the sensor 141 of the sensing and distributing unit 14 so as to adjust rotation speeds of the heat dissipating fan 2 response to the variation of the sensing and distributing unit 14, referring to FIGS. 4 and 5.

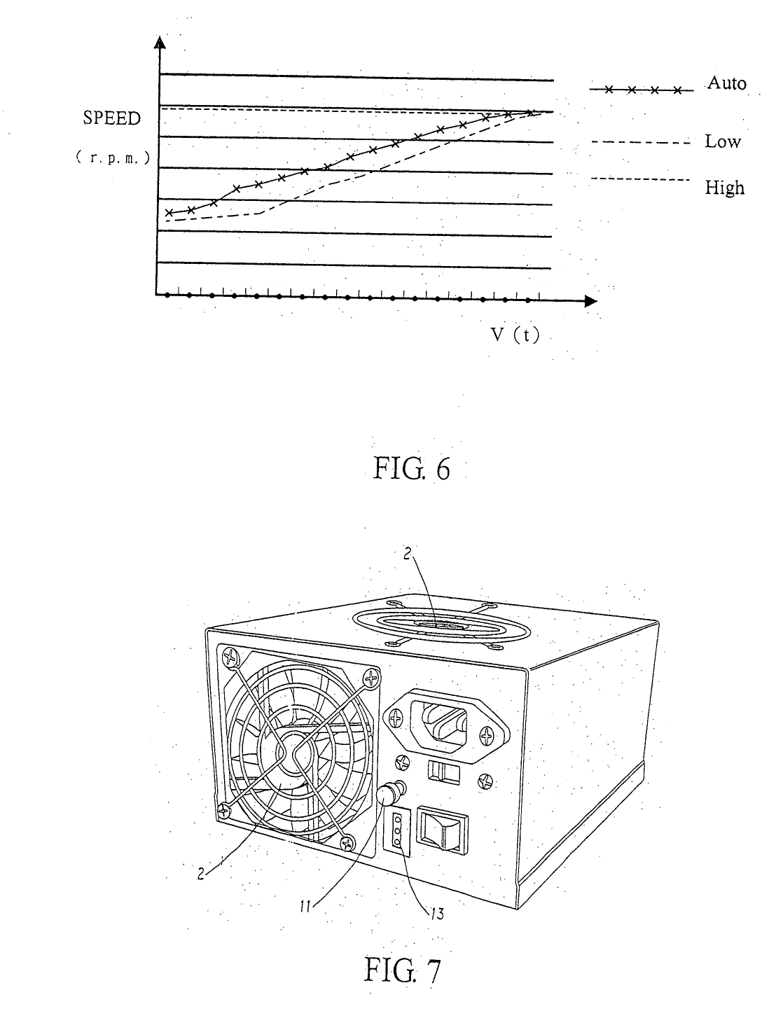

Moreover, one ends of the resistors 142, 143 are connected to switching and display units 132, 133, respectively, and another ends of the resistors 142, 143 are connected to the heat dissipating fan 2. When the switching and display units 132, 133 are actuated and conducted by the control unit 12, currents flow through the resistors 142, 143 so that the voltage across the two ends of the heat dissipating fan 2 will be reduced. Thereby, the rotation speed of the heat dissipating fan 2 is adjustable (referring to FIGS. 5 and 6).

To be operated steadily and safely, normally, the control unit 12 actuates the switching and display unit 133 to conduct the resistor 143, the heat dissipating fan 2 is set at a predetermined temperature (for example, 25° C.) to be operated with a lower rotation speed so as to reduce noise in normal temperature. When the environmental temperature is increased abruptly or the work load of an IC is increased abruptly, the thermal resistor THR will sense the variation of temperature, when the temperature is increased to a limiting value and the heat dissipating fan 2 rotates in a low speed, the control unit 12 will be actuated, and the switching and display unit 131 works, thereby, the heat dissipating fan 2 changing the rotation speed with the variation of temperature. When the control unit 12 actuates to drive the switching and display unit 131, the resistor 143 is connected in parallel to the heat dissipating fan 2 and thus the voltage of the heat dissipating fan 2 will decrease. Then the rotate speed of the fan 2 will decrease. On the contrary, when the environmental temperature reduces to be below the set value, the control unit 12 will cut off the switching and display unit 141. Then the switching and display unit 143 serves to actuate the heat dissipating fan 2 to rotate at a lower speed. Thereby, in the present invent-ion, when the heat dissipating fan 2 is switched to a lower rotation speed, the system can be protected automatically.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multi-mode modulation and display device of heat dissipating fans of a computer power supply having an input end connected to a power supply and an output end thereof electrically connected to at least one heat dissipating fan, the multi-mode modulation and display device comprising;
a trigger; the trigger being driven by users to generate pulse signals;
a control unit being actuated by the pulse signals from the trigger to act sequentially;
a switching and display module formed by at least three switching and display units; an output end of the switching and display module being connected to output ends of the control unit; wherein when the output ends of the control unit are conducted, the switching and display units connected to the control unit are conducted so that lamps in the switching and display units light up;
a sensing and distributing unit connected to an output end of the switching and display module; the sensing and distributing unit including at least one sensor and at least two resistors with different resistances; the sensor being driven by one of the at least three switching and display units for detecting temperature variations of environment and then changing resistance thereof;
wherein one ends of the two resistors and heat dissipating fan are connected to the switching and display units, respectively, and another ends of the two resistors are connected to another ends of the heat dissipating fan; when the switching and display units are actuated and conducted by the control unit, currents flow through the resistors so that the voltage across the heat dissipating fan will be reduced; thereby, the rotation speed of the heat dissipating fan is adjustable.

2. The multi-mode modulation and display device of heat dissipating fans of a computer power supply as claimed in claim 1, wherein the trigger is one of a key switch and a film switch.

3. The multi-mode modulation and display device of heat dissipating fans of a computer power supply as claimed in claim 1, wherein the trigger is connected to a computer mainframe so that the user can control the trigger through a computer having the computer mainframe.

4. The multi-mode modulation and display device of heat dissipating fans of a computer power supply as claimed in claim 1, wherein lamps of the switching and display module are light emitting diodes (LEDs).

5. The multi-mode modulation and display device of heat dissipating fans of a computer power supply as claimed in claim 1, wherein the sensor includes
a Zener diode; and
a thermal resistor for sending environment temperature; and changing a resistance thereof; the resistance being then feedback to the Zener diode so as to actuate the Zener diode to adjust rotation speed of the heat dissipating fan.
